(19) United States
(12) Patent Application Publication
(10) Pub. No.: US 2003/0172683 A1
(43) Pub. Date: Sep. 18, 2003

(54) Rovings and methods and systems for producing rovings

(76) Inventors: Chi Tang, Concord, NC (US); Paul A. Westbrook, Shelby, NC (US); Christopher G. Cross, Forest City, NC (US); Pu Gu, Gastonia, NC (US); James C. Peters, Shelby, NC (US); John L. Sarratt, Bolling Springs, NC (US)

Correspondence Address: J. Jason Link, Kilpatrick Stockton LLP, 1001 West Fourth Street, Winston-Salem, NC, 27101, US

(21) Appl. No.: 10/364,726

(22) Filed: Feb. 11, 2003

Related U.S. Application Data
(60) Provisional application No. 60/355,913, filed on Feb. 11, 2002.

(51) Int. Cl. C03C 25/10

(52) U.S. Cl. 65/529

(57) ABSTRACT

A fiber glass roving comprises a plurality of ends from a plurality of direct draw packages, each direct draw package having a single end. Ends from a plurality of direct draw packages may be combined to form a roving at a point of use, such as just prior to chopping the roving in a chopping gun. Assembled rovings may also be formed by winding a plurality of ends from a plurality of direct draw packages, each direct draw package having a single end, into an assembled roving package.

### CROSS REFERENCE TO RELATED APPLICATION

This application claims priority to, and incorporates by reference in full, the following co-pending application of Applicant: U.S. Provisional Patent Application No. 60/355,913, filed Feb. 11, 2002, entitled “Rovings and Method and Apparatus for Producing Rovings from a Direct Draw Package.”

### FIELD OF THE INVENTION

The present invention relates generally to fiber glass rovings and to methods and systems for producing rovings and composite products from direct draw packages.

### BACKGROUND OF THE INVENTION

In the fiber glass industry, roving products are used in a number of applications. For example, in a gun roving application, a fiber glass roving product or roving is fed to a chopper gun, which chops the roving into short segments of fiber glass. The chopped roving is mixed with resin and sprayed onto a mold. At least one worker then rolls the sprayed fiber glass/resin composite on the mold to flatten it, spread it evenly, and facilitate wetting. The composite then cures and is usually removed from the mold, resulting in a composite having a desired shape.

Roving packages are conventionally manufactured by winding fiber glass ends from at least two forming packages to form an assembled roving. The ends are formed when glass filaments are drawn from a fiber forming apparatus, bushing, connected to a supply of molten glass. The filaments are gathered into one or more ends and wound upon a rotating collet of a forming winder to create a forming package. During winding, a collet rotates about a horizontal, longitudinal axis to wind the ends and oscillates in order to build a forming package. Multiple ends (typically two to twelve) are wound into a single forming package or forming cake. Forming winders typically have a twelve inch oscillating collet and typically operate at winding speeds of 3,000 meters per minute. At a winding speed of 3,000 meters per minute and with a twelve inch collet, a forming winder would be operating at approximately 3,100 revolutions per minute. The forming winders utilize spiral arms to assist in building forming packages. The spiral arms control the placement of the ends in order to gradually and evenly build a forming package.

Roving packages are formed by gathering a plurality of ends from a plurality of forming packages (each forming package having two to twelve ends), and winding the ends about a collet rotating about a horizontal, longitudinal axis using a roving winder. Rovings formed in this manner are referred to as “assembled rovings.” Conventional assembled rovings typically are formed by winding 30 to 60 ends. For example, a conventional assembled roving with a desired yield of 200 yards per pound may be formed by winding twelve forming packages on a roving winder, each forming package having four ends and each end having 200 filaments and filament diameters of ten to thirteen microns. The ends typically have a circular or oval cross section.

Roving applications, such as gun roving applications, require fiber glass strands formed from numerous ends having high filament counts. Current assembled rovings used in roving applications have a number of disadvantages. One major concern with current rovings is splitting efficiency, “Slitting efficiency” is a measure of the roving's ability to separate back into ends after it is chopped to facilitate the rolling process. As used herein, “splitting efficiency” refers to the apparent number of ends after chopping the roving divided by the total number of ends actually used to form the roving. Splitting efficiency is often expressed as a percentage. While it would be desirable to have a splitting efficiency of 100%, such a splitting efficiency is not commercially available using current assembled roving products.

Other disadvantages seen with current assembled roving products include, for example, difficulties in pay out due to catenaries on the surface of the assembled roving, high labor costs involved with rolling out the chopped rovings, and “spring back” and “conformity” issues upon rolling.

### SUMMARY

The present invention relates to fiber glass rovings, to fiber glass gun rovings, and to assembled fiber glass rovings. The present invention also relates to methods and systems for forming fiber glass rovings, to methods and systems for forming fiber glass gun rovings, and to methods and systems for forming assembled fiber glass rovings. The present invention also relates to methods and systems for forming composite products. The present invention also relates to packaging units.

In one non-limiting embodiment, a fiber glass gun roving comprises a plurality of ends from a plurality of direct draw packages, each direct draw package having a single fiber glass end. The direct draw packages are wound using a direct draw winder, which results in a cylindrical package with two substantially flat surfaces. Examples of direct draw winders useful in embodiments of the present invention allow a plurality of ends from a singe bushing to be wound into multiple direct draw packages at high speeds, each direct draw package having a single fiber glass end. Among other features, the use of a direct draw winder to wind an end into a direct draw package, in one embodiment, produces an end with a flatter cross-section than ends wound on conventional forming winders. The cross-section of an end wound into a direct draw package may be characterized in terms of its effective aspect ratio. In one non-limiting embodiment of a gun roving, the effective aspect ratio of each end is greater than 5.9. In further non-limiting embodiments, the effective aspect ratio of each end may be between 5.9 and 10.

One non-limiting embodiment of an assembled fiber glass roving comprises a wound package comprising between ten and two hundred fiber glass ends from a plurality of direct draw packages, each direct draw package having a single fiber glass end. The assembled roving may be wound using a roving winder.

One non-limiting embodiment of a method for forming a fiber glass gun roving comprises providing a plurality of direct draw packages, each direct draw package having a hollow center and a single fiber glass end; feeding the end from each direct draw package through the center of the direct draw package; and combining the ends to form a gun roving. Each end may be wound into a direct draw package using at least one direct draw winder and at least four direct draw packages are capable of being wound on each direct draw winder. The effective aspect ratio of each end, in further non-limiting embodiments, may be greater than 5.9. In further non-limiting embodiments, the effective aspect ratio of each end may be between 5.9 and 10.

In one non-limiting embodiment, a method for forming an assembled fiber glass roving comprises providing a plurality of direct draw packages, each direct draw package having a hollow center and a single fiber glass end; and winding the ends from the plurality of direct draw packages to form an assembled fiber glass roving. Each end may be wound into a direct draw package using at least one direct draw winder with a single direct draw winder being capable of winding at least four direct draw packages at the same time. The effective aspect ratio of each end, in non-limiting embodiments, may be greater than 5.9, and may further be between 5.9 and 10. In one non-limiting embodiment, the assembled roving is cylindrical with two substantially flat surfaces and each of the substantially flat surfaces is substantially free of catenaries.

One non-limiting embodiment of a system for forming assembled fiber glass rovings comprises a supply of molten glass; at least one bushing; at least one binder applicator; at least one direct draw winder capable of simultaneously winding four or more direct draw packages; and a roving winder. The molten glass may be supplied to the at least one bushing, which forms fiber glass filaments. The fiber glass filaments are at least partially coated with a binder and may be gathered into at least four ends. The at least four ends may be wound into at least four direct draw packages on the at least one direct draw winder, with each direct draw package having a single end. The ends from the direct draw packages may be assembled at the roving winder to form an assembled roving.

The present invention also relates to methods and systems for forming composite products. In one non-limiting embodiment, a method for forming composite products comprises combining a plurality of fiber glass ends from a plurality of direct draw packages, each direct draw package having a single end, to form a roving; supplying the roving to a roving gun; chopping the roving; at least partially mixing the chopped roving with a resin; spraying the mixed roving and resin on a mold; and rolling the mixed roving and resin on the mold. The direct draw packages may be wound using a direct draw winder that is capable of simultaneously winding four or more direct draw packages. The ends from each direct draw package may be combined to form the roving, in one non-limiting embodiment, just prior to supplying the roving to the chopping gun.

In another non-limiting embodiment, a method for forming composite products comprises winding a plurality of fiber glass ends from a plurality of direct draw packages, each direct draw package having a single end, to form an assembled roving; supplying the assembled roving to a roving gun; chopping the assembled roving; at least partially mixing the chopped roving with a resin; spraying the mixed roving and resin on a mold; and rolling the mixed roving and resin on the mold.

Systems for forming composite products, in one non-limiting embodiment, may comprise a plurality of direct draw packages, each direct draw package having a single fiber glass end; a source of resin; a roving gun; and a mold. The ends from the direct draw packages may be supplied to the roving gun and combined to form a roving just prior to supplying the ends to the roving gun. The roving gun chops the roving and the roving is at least partially mixed with the resin. The mixed roving and resin may be sprayed on the mold and then rolled to form the composite.

### BRIEF DESCRIPTION OF THE FIGURES

The following description, will be better understood when read in conjunction with the appended drawings. In the drawings:

FIG. 1 is a schematic of a non-limiting embodiment of a process of the present invention for manufacturing direct draw packages.

FIG. 2 illustrates a cross-section of a non-limiting embodiment of a fiber glass end of the present invention.

FIG. 3 illustrates an embodiment of an assembled roving of the present invention compared to a conventional assembled roving.

FIG. 4 illustrates a perspective view of a non-limiting embodiment of a method of the present invention for forming a roving by stacking direct draw packages.

FIG. 5 illustrates a top view of a non-limiting embodiment of a method of the present invention for forming a roving by stacking direct draw packages.

FIG. 6 is a perspective view of a non-limiting embodiment of a packaging unit of the present invention.

FIG. 7 is a side view of a non-limiting embodiment of a packaging unit of the present invention.

FIG. 8 is a top view of a non-limiting embodiment of a packaging unit of the present invention.

FIG. 9 is a perspective view of another non-limiting embodiment of a packaging unit of the present invention.

FIG. 10 is a side view of another non-limiting embodiment of a packaging unit of the present invention.

FIG. 11 is an end view of another non-limiting embodiment of a packaging unit of the present invention.

FIG. 12 is a top view of another non-limiting embodiment of a packaging unit of the present invention.

### DETAILED DESCRIPTION OF THE INVENTION

For the purposes of this specification, unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in the following specification are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

The present invention relates to fiber glass rovings, fiber glass gun rovings, assembled fiber glass rovings, methods and systems for forming fiber glass gun rovings, and methods and systems for forming assembled fiber glass rovings. The present invention also relates to methods and systems for forming composite products. The present invention also relates to packaging units.

As used herein, the term “end” means a plurality of individual filaments that are at least partially coated with a binder and gathered together for subsequent use or processing. The term “strand,” as used herein, refers to a plurality of ends.

The present invention is generally useful in the winding of textile ends, yarns or the like of natural, man-made or synthetic materials, and in the formation of rovings from textile ends, yarns or the like. Non-limiting examples of such natural fibers include cotton fibers; man-made fibers include cellulosic fibers such as rayon and graphite fibers; and synthetic fibers including polyester fibers, polyolefin fibers such as polyethylene or polypropylene, and polyamide fibers such as nylon and aromatic polyamide fibers (an example of which is Kevlar™, which is commercially available from E. I. Dupont de Nemours Co. of Wilmington, Del.).

The present invention will now be discussed generally in the context of its use in the production, assembly, and application of glass fibers. However, one of ordinary skill in the art would understand that the present invention is useful in the processing of any of the textile materials discussed above.

Persons of ordinary skill in the art will recognize that the present invention can be implemented in the production, assembly, and application of a number of glass fibers. Non-limiting examples of glass fibers suitable for use in the present invention can include those prepared from fiberizable glass compositions such as “E-glass”, “A-glass”, “C-glass”, “S-glass”, “ECR-glass” (corrosion resistant glass), and fluorine and/or boron-free derivatives thereof.

The present invention advantageously utilizes direct draw winders in the winding of fiber glass. For example, the present invention advantageously utilizes direct draw winders to wind fiber glass ends into direct draw packages for use in gun roving applications. Examples of direct draw winders useful in the present invention allow a plurality of ends from a single bushing to be wound into multiple direct draw packages at high speeds, each direct draw package having a single fiber glass end.

In one non-limiting embodiment, the direct draw winder can wind ends of fiber glass at speeds up to 4,500 meters per minute. With a collet of diameter of 230 millimeters, this winding speed corresponds to approximately 6,200 revolutions per minute. As winder technology evolves, higher winding speeds will likely become available, and direct draw winders with higher winding speeds could advantageously be used in the present invention. With direct draw winders, the ends are wound into packages using a traverse guide (as opposed to oscillating collets), which physically moves the end to build the direct draw package. The combination of a traverse guide and the high winding speed produces an end that is non-circular and flatter than ends wound on a conventional forming winder. By winding each end into a separate package at high speeds, direct draw winders advantageously allow larger fiber filaments and larger bundle sizes to be wound into packages for use in gun roving applications, reduce problems of catenary, and result in a flatter end for improved downstream processing.

Non-limiting embodiments of the present invention may utilize a direct draw winder that is a high-speed, multiple package direct draw winder. The direct draw winder, in some embodiments may also be a non-contact direct draw winder, meaning, for example, that the winder does not use a contact bar (or contacting strand guide). A direct draw winder useful in the present invention can wind four to twelve ends into four to twelve direct draw packages at low cost with each end being wound into separate direct draw packages. Direct draw winders that can wind more direct draw packages may also be useful in the embodiments of the present invention. In another non-limiting embodiment, a direct draw winder useful in the present invention can wind six ends into six direct draw packages at low cost with each end being wound into separate direct draw packages.

As noted above, each fiber glass end is wound on the direct draw winders to form a separate direct draw package for each end. A fiber glass end on a direct draw package of the present invention can comprise up to eight hundred filaments per end. The fiber glass ends, in one non-limiting embodiment, have flatter, non-circular cross-sections when compared with ends wound on conventional forming winders.

Non-limiting embodiments of the present invention relate to fiber glass rovings, to fiber glass gun rovings, and to assembled fiber glass rovings. In one non-limiting embodiment, a fiber glass gun roving comprises a plurality of ends from a plurality of direct draw packages, each direct draw package having a single fiber glass end. The direct draw packages are wound using a direct draw winder, which resulting a cylindrical package with two substantially flat surfaces. At least four direct draw packages may be wound on a single direct draw winder. The use of a direct draw winder to wind an end produces an end with a flatter cross-section than ends wound on conventional forming winders. The cross-section of an end wound into a direct draw package may be characterized in terms of its effective aspect ratio (discussed in more detail below). In one non-limiting embodiment of a gun roving, the effective aspect ratio of each end is greater than 5.9. In further non-limiting embodiments, the effective aspect ratio of each end may be between 5.9 and 10.

The ends from the direct draw packages are “loosely grouped” to form the gun roving. As used herein, the term “loosely grouped” means that the ends are combined together so that the ends may be processed or used at the same time (e.g., fed to a roving gun), but without adhering the ends to one another.

Each end may comprise up to 800 filaments. In one embodiment, each end may comprise up to 600 filaments. In a further embodiment, the end may comprise up to 500 filaments. In other non-limiting embodiments, each end may comprise more than 200 filaments. Each end may comprise more than 300 filaments in other embodiments. With regard to diameter, the filaments may have diameters up to sixteen microns in some non-limiting embodiments. The diameters of the filaments may be up to thirteen microns in further non-limiting embodiments. In other non-limiting embodiments, the diameter of the filaments may be between six and sixteen microns. The diameter of the filaments, in one non-limiting embodiment, may be between nine and thirteen microns.

The gun roving, in one non-limiting embodiment, comprises between ten and two hundred fiber glass ends. The number of ends may depend on the desired yield (usually expressed in yards per pound) of the gun roving. For example, in an embodiment where the yield of the gun roving is less than three hundred yards per pound, the gun roving may comprise up to fifty ends. In a further non-limiting embodiment where the yield of the gun roving is between one hundred and three hundred yards per pound, the gun roving may comprise between twenty and fifty ends. In one non-limiting embodiment where the desired yield of the gun roving is less than two hundred fifty yards per pound, the gun roving may comprise up to forty ends. In a further non-limiting embodiment where the desired yield of the gun roving is between one hundred fifty and two hundred fifty yards per pound, the gun roving may comprise between twenty-four and forty ends.

In one non-limiting embodiment, a gun roving having a desired yield of between one hundred and three hundred yards per pound, the gun roving comprises between twenty and fifty ends, with each end having between 300 and 500 filaments and with each filament having a diameter between nine and thirteen microns.

Gun rovings of the present invention exhibit improved splitting efficiencies over conventional gun roving products. Non-limiting embodiments of gun rovings may exhibit splitting efficiencies greater than 90% after being chopped and sprayed from a roving gun, preferably greater than 95%. Gun rovings of the present invention also exhibit desirable conformities after being chopped and sprayed from a roving gun and mixed with a resin. Non-limiting embodiments of gun rovings may exhibit conformities of less than 1.5.

The present invention also relates to assembled fiber glass rovings. In one non-limiting embodiment, an assembled fiber glass roving comprises a wound package comprising between ten and two hundred fiber glass ends from a plurality of direct draw packages, each direct draw package having a single fiber glass end. The assembled roving may be wound using a roving winder. Assembled fiber glass rovings of the present invention may have similar properties and characteristics as gun rovings of the present invention. The ends from the direct draw packages are also “loosely grouped” when they are wound into an assembled roving.

In another non-limiting embodiment of the present invention, the ends from a plurality of direct draw packages are combined to form a roving package of the present invention at the point of use. Each direct draw package, in a non-limiting embodiment, comprises a single fiber glass end. In other non-limiting embodiments, each direct draw package is paid out from the interior, meaning that the end of the end is pulled from the inside of the package such that the package unwinds from the inside outward. In a non-limiting example, the packages can be stacked and the ends from each of the packages can be fed through the center of the packages. The ends from the stacked packages can be combined to form a roving product of the present invention.

A non-limiting embodiment of a method of the present invention for forming roving products comprises aligning a plurality of direct draw packages, each direct draw package having a hollow center and having a single fiber glass end, paying out or unwinding the end from each package through the center of the direct draw packages, and combining the ends to form a roving product.

In another non-limiting embodiment, a method for forming a fiber glass gun roving comprises providing a plurality of direct draw packages, each direct draw package having a hollow center and a single fiber glass end; feeding the end from each direct draw package through the center of the direct draw package; and combining the ends to form a gun roving. In this embodiment, each end is wound into a direct draw package using at least one direct draw winder and at least four direct draw packages are capable of being wound on each direct draw winder. The effective aspect ratio of each end, in non-limiting embodiments, may be greater than 5.9, and may further be between 5.9 and 10.

In a further embodiment wherein the yield of the gun roving is less than three hundred yards per pound, up to fifty direct draw packages may be provided. In a still further embodiment wherein the yield of the gun roving is between one hundred and three hundred yards per pound, between twenty and fifty direct draw packages may be provided. In another embodiment wherein the yield of the gun roving is less than two hundred fifty yards per pound, up to forty direct draw packages may be provided. In another embodiment wherein the yield of the gun roving is between one hundred fifty and two hundred fifty yards per pound, between twenty-four and forty direct draw packages may be provided.

In using methods of the present invention to form a gun roving, the gun roving may exhibit a splitting efficiency greater than 90% after being chopped and sprayed from a roving gun and preferably greater than 95%.

The present invention also relates to methods for forming an assembled fiber glass roving. In one non-limiting embodiment, a method for forming an assembled fiber glass roving comprises providing a plurality of direct draw packages, each direct draw package having a hollow center and a single fiber glass end; and winding the ends from the plurality of direct draw packages to form an assembled fiber glass roving. Each end was wound into a direct draw package using at least one direct draw winder with a single direct draw winder being capable of winding at least four direct draw packages at the same time. The effective aspect ratio of each end, in non-limiting embodiments, may be greater than 5.9, and may further be between 5.9 and 10.

In one non-limiting embodiment, the assembled roving is cylindrical with two substantially flat surfaces and each of the substantially flat surfaces is substantially free of catenaries.

In a further embodiment wherein the yield of the assembled roving is up to three hundred yards per pound, up to fifty direct draw packages may be provided. In a further embodiment wherein the yield of the assembled roving is between one hundred and three hundred yards per pound, between twenty and fifty direct draw packages may be provided. In another embodiment wherein the yield of the assembled roving up to two hundred fifty yards per pound, up to forty direct draw packages may be provided. In further embodiment wherein the yield of the assembled roving is between one hundred fifty and two hundred fifty yards per pound, between twenty-four and forty direct draw packages may be provided.

In using methods of the present invention to form an assembled roving for use in gun roving applications, the gun roving may exhibit a splitting efficiency greater than 90% after being chopped and sprayed from a roving gun, preferably greater than 95%.

The present invention also relates to systems for forming assembled fiber glass rovings. In one non-limiting embodiment, a system for forming assembled fiber glass rovings comprises a supply of molten glass; at least one bushing; at least one binder applicator; at least one direct draw winder capable of simultaneously winding four or more direct draw packages; and a roving winder. The molten glass is supplied to the at least one bushing, which forms fiber glass filaments. The fiber glass filaments are at least partially coated with a binder and are gathered into at least four ends. The at least four ends are wound into at least four direct draw packages on the at least one direct draw winder, with each direct draw package having a single end. The ends from the direct draw packages may be assembled at the roving winder to form an assembled roving.

The at least one bushing, in some embodiments, may produce at least four ends, with each end having up to 600 filaments. In a further embodiment, the at least one bushing may produce at least four ends, with each end having up to 500 filaments. The at least one bushing, in some non-limiting embodiments, may produce at least four ends, with each end having greater than 200 filaments. The at least one bushing, in further non-limiting embodiments, may produce at least four ends, with each end having greater than 300 filaments. The diameter of each filament may be up to sixteen microns in further non-limiting embodiments. In a further embodiment, the diameter of each filament may be up to thirteen microns. In other non-limiting embodiments, each filament may have a diameter greater than six microns. In some non-limiting embodiments, each filament may have a diameter greater than nine microns. In other embodiments, the at least one bushing may be able to produce at least six ends. For example, in one non-limiting embodiment, the at least one bushing is able to produce at least six ends, each end having between 300 and 500 filaments. In further embodiments, the diameter of each filament may be between nine and thirteen microns.

Molten glass may be supplied in a number of ways, such as direct-melt fiber forming operations and indirect, or marble-melt, fiber forming operations. In a direct-melt fiber forming operation, raw materials are combined, melted and homogenized in a glass melting furnace. The molten glass moves from the furnace to a forehearth and into fiber forming apparatuses or bushings (discussed below) where the molten glass is attenuated into continuous glass fibers. In a marble-melt glass forming operation, pieces or marbles of glass having the final desired glass composition are preformed and fed into a bushing where they are melted and attenuated into continuous glass fibers. If a premelter is used, the marbles are fed first into the premelter, melted, and then the melted glass is fed into a fiber forming apparatus where the glass is attenuated to form continuous fibers. For additional information relating to glass compositions and methods of forming the glass fibers, see K. Loewenstein, The Manufacturing Technology of Continuous Glass Fibres, (3d Ed. 1993), at pages 30-44, 47-103, and 115-165, which are specifically incorporated by reference herein.

In further embodiments, after winding, the direct draw packages may be at least partially dried using techniques known to those of ordinary skill in the art. For additional information relating to drying, see K. Loewenstein, The Manufacturing Technology of Continuous Glass Fibres, (3d Ed. 1993), at pages 219-222, which are specifically incorporated by reference herein.

The present invention also relates to packaging units. In one non-limiting embodiment, a packaging unit of the present invention comprises a pallet and a plurality of direct draw packages arranged on the pallet, each direct draw package having a hollow center and having a single end, wherein the plurality of direct draw packages are arranged such that the ends from each of the plurality of direct draw packages can be paid out from the center of the packages and combined to form a roving.

In another non-limiting embodiment, the packaging unit can comprise twice as many direct draw products as necessary to form a roving. In this embodiment, a first set of direct draw packages (i.e., half of the packaging unit) is paid out to form a roving. The first set of direct draw packages can be connected to the second set of direct draw packages in order to provide a continuous supply of roving. When the first set of packages is paid out, the next set of packages begins paying out or unwinding to form the roving. Likewise, a plurality of packaging units can be connected to provide a longer supply of roving, such that the supply of roving is not interrupted.

The direct draw packages can be arranged on the pallet in a number of ways. In one non-limiting embodiment, the direct draw packages can be stacked vertically. In another non-limiting embodiment, the direct draw packages can be arranged in horizontal rows. In this embodiment, a package rack can be utilized to prevent the packages in adjacent rows from contacting each other. The arrangement of the direct draw packages can vary depending on the number of direct draw packages needed for a roving, any size limitations on the pallet, the dimensions of the direct draw packages, and other factors.

The present invention also relates to methods and systems for forming composite products. In one non-limiting embodiment, a method for forming composite products comprises combining a plurality of fiber glass ends from a plurality of direct draw packages, each direct draw package having a single end, to form a roving; supplying the roving to a roving gun; chopping the roving; at least partially mixing the chopped roving with a resin; spraying the mixed roving and resin on a mold; and rolling the mixed roving and resin on the mold. The direct draw packages are wound using a direct draw winder that is capable of simultaneously winding four or more direct draw packages. The ends from each direct draw package may be combined to form the roving, in one non-limiting embodiment, just prior to supplying the roving to the chopping gun. For example, the operator of a chopping gun may feed the ends from a plurality of direct draw packages directly into the gun. The ends may be pulled from the direct draw packages themselves rather than from an assembled roving package.

The rovings may exhibit splitting efficiencies greater than 90% after being chopped and sprayed from the roving gun, preferably greater than 95%. Gun rovings used in methods of the present invention for forming composites may exhibit desirable conformities after the mixed roving and resin are rolled on the mold. For example, gun rovings may exhibit conformities of less than 1.5.

In another non-limiting embodiment, a method for forming composite products comprises winding a plurality of fiber glass ends from a plurality of direct draw packages, each direct draw package having a single end, to form an assembled roving; supplying the assembled roving to a roving gun; chopping the assembled roving; at least partially mixing the chopped roving with a resin; spraying the mixed roving and resin on a mold; and rolling the mixed roving and resin on the mold. In this embodiment, the direct draw packages may be wound using a direct draw winder capable of simultaneously winding four or more direct draw packages. In a further embodiment, an assembled roving supplied to the roving gun may be cylindrical with two substantially flat surfaces, which are substantially free of catenaries.

The assembled rovings may exhibit splitting efficiencies greater than 90% after being chopped and sprayed from the roving gun, preferably greater than 95%. Assembled rovings used in methods of forming composites also exhibit desirable conformities after the mixed roving and resin are rolled on the mold. For example, assembled rovings may exhibit conformities of less than 1.5.

The present invention also relates to systems for forming composite products. In one non-limiting embodiment, a system for forming composite products may comprise a plurality of direct draw packages, each direct draw package having a single fiber glass end; a source of resin; a roving gun; and a mold. The ends from the direct draw packages may be supplied to the roving gun and combined to form a roving just prior to supplying the ends to the roving gun. The roving gun chops the roving and the roving is at least partially mixed with the resin. The mixed roving and resin are sprayed on the mold and then rolled to form the composite.

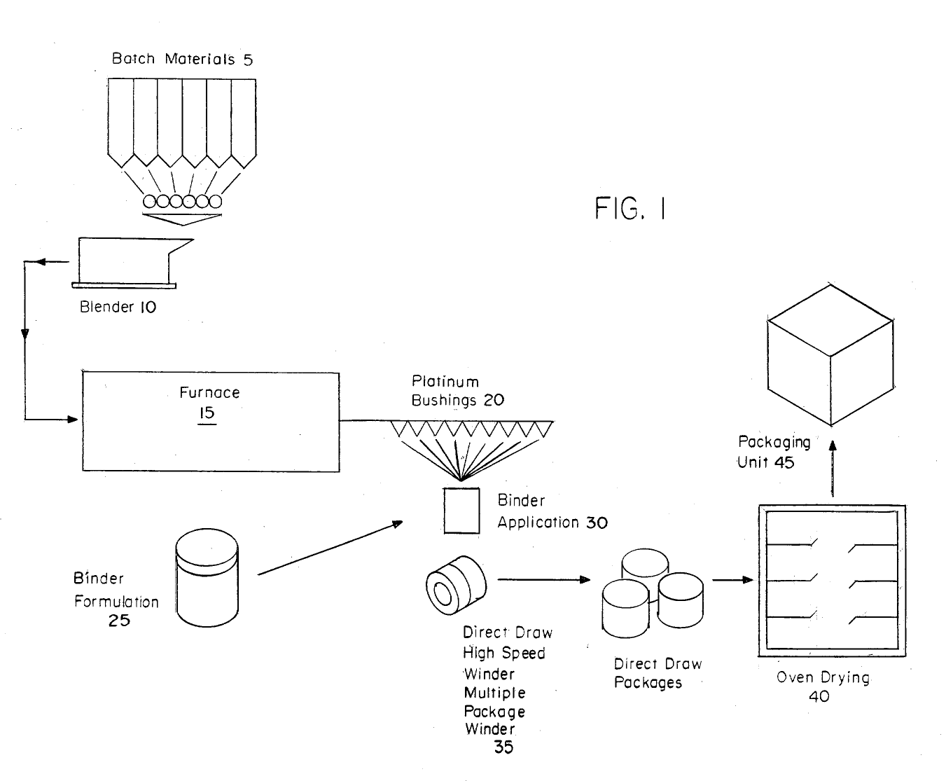

FIG. 1 is a schematic of a non-limiting embodiment of a process and a system of the present invention for manufacturing direct draw packages. Batch materials for making fiber glass are transferred from storage hoppers 5 to a mixing apparatus, such as a blender 10. The mixed batch materials are transported to a furnace 15, where they are heated to form molten glass. The molten glass is formed from the batch materials in a manner known to those of ordinary skill in the art. The molten glass then passes through a bushing 20 (or other fiber forming apparatus) to form fiber glass filaments.

The fiber glass filaments are then at least partially coated with a binder 25 using a binder applicator 30. As used herein, the term “binder” has the same meaning as “size”, “sized”, or “sizing”, and refers to the aqueous composition applied to the filaments immediately after formation of the glass fibers.

The coating of the surfaces of glass fibers with a binder protects the glass fibers from interfilament abrasion when gathered into an end. Typical binders can include as components film-formers such as starch and/or thermoplastic or thermosetting polymeric film-formers and mixtures thereof, lubricants such as animal, vegetable or mineral oils or waxes, coupling agents, emulsifiers, antioxidants, ultraviolet light stabilizers, colorants, antistatic agents and water, to name a few. Non-limiting examples of binders suitable for use in the present invention are set forth in U.S. Pat. No. 6,139,958, and in K. Loewenstein, The Manufacturing Technology Continuous Glass Fibres, (3rd. 1993), at pages 275-77, each of which are hereby incorporated by reference.

One non-limiting example of a suitable binder for use in coating fiber glass products of the present invention comprises at least one film-former, at least one coupling agent, a lubricant and an antifoaming agent. If the binder comprises two film-formers, one film-former may be a major (or primary) film-former and the other may be a minor (or secondary film-former).

A major (or primary) film-former may be, in one non-limiting embodiment of a binder useful in the present invention, an unsaturated polyester dispersion. A non-exclusive example of an unsaturated polyester dispersion is an aqueous soluble, dispersible, or emulsifiable bisphenol A polyester polymer like one formed from bisphenol A, butene diol or maleic anhydride or maleic acid and adipic acid with internal and/or external emulsification through the use of a polyalkylene polyol such as polyethylene glycol. The polyester may be internally emulsified through ethoxylation for a polymer with a weight average molecular weight in the range of about 30,000 to about 45,000 and has a polydispersity index Mw/Mn of 9 or less and preferably around 5 to around 9.

A non-limiting example of such a polymer is the single aqueous emulsion of alkoxylated bisphenol A polyester resin commercially available under the trade designation NEOXIL® 954/D and manufactured by DSM Italia, Como, Italy and which is the reaction product of diglycidyl ether of bisphenol-A and butene diol and adipic acid and maleic anhydride and propylene and ethylene glycols that is essentially free of unreacted epoxy groups. For additional information relating to NEOXIL® 954/D, see U.S. Pat. No. 6,139,958, which is specifically incorporated by reference herein. Additional nonexclusive examples of bisphenol A polyester resins are those available in an aqueous emulsion form under the trade designation NEOXIL® 952 from DSM Italia.

In one non-limiting embodiment, the amount of major film-former can comprise fifty (50) to one hundred (100) weight percent of the binder based on total solids. In another non-limiting embodiment, the amount of major film-former can comprise between seventy-five (75) and one hundred (100) weight percent of the binder based on total solids. In a further embodiment, the amount of major film-former can comprise between eighty-five (85) and ninety-five (95) weight percent of the binder based on total solids.

A minor (or secondary) film-former may be, in one non-limiting embodiment of a binder useful in the present invention, a high molecular weight epoxy. A non-exclusive example of a high molecular weight epoxy useful in non-limiting embodiments of the present invention is a polyepoxide film-former having epoxy equivalent weights between about 500 and 1700. A non-limiting example of such a polyepoxide film-former is commercially available under the trade designation NEOXIL® 8294 from DSM Italia. Another non-limiting example of a suitable polyepoxide film-former is commercially available under the trade designation EPI-REZ Resin 3522-W-60 from Resolution Performance Products.

Other polyesters with different molecular weights or degrees of unsaturation could also be used as secondary film-formers. An additional nonexclusive example of a bisphenol A polyester resin is available in an aqueous emulsion form under the trade designation NEOXIL® 952 from DSM Italia. The aqueous emulsion of the NEOXIL® 952 material is an nonionic emulsion that has a liquid, milky appearance with a solid content of 40+/−2 percent and a pH in the range of 3 to 5.

Other examples of secondary film-formers useful in the present invention include plasticizing resins, such as adipate polyesters. One example of an adipate polyester is NEOXIL® 9166 from DSM Italia.

In one non-limiting embodiment, the amount of minor film-former can comprise zero (0) to fifty (50) weight percent of the binder based on total solids. In another non-limiting embodiment, the amount of minor film-former can comprise between zero (0) and twenty-five (25) weight percent of the binder based on total solids. In a further embodiment, the amount of minor film-former can comprise between five (5) and fifteen (15) weight percent of the binder based on total solids.

Binders useful in the present invention may also comprise one or more coupling agents. Non-limiting examples of coupling agents that can be used in the binders of the present invention include organo-silane coupling agents, transition metal coupling agents, amino-containing Werner coupling agents and mixtures thereof. These coupling agents typically have dual functionality. Each metal or silicon atom has attached to it one or more groups which can react with the glass fiber surface or otherwise be chemically attracted, but not necessarily bonded, to the glass fiber surface. Conventionally, the other functionality included in coupling agents provides reactivity or compatibilization with film forming polymers.

Although not required, organo silane compounds are the preferred coupling agents in the present invention. Non-limiting examples of suitable organo silane coupling agents include A-187 gamma-glycidoxypropyltrimethoxysilane, A-1100 gamma-aminopropyltriethoxysilane, A-174 gamma-methacryloxypropyltrimethoxysilane, and A-1120 N-beta-aminoethyl)-gamma-aminopropyltrimethoxysilane, each of which is commercially available from OSi Specialties of Tarrytown, N.Y. Although not limiting in the present invention, the amount of coupling agent can be between zero (0) to ten (10) weight percent of the binder on a total solids basis. In further embodiments, the amount of coupling agent can be between zero (0) to five (5) weight percent of the binder on a total solids basis.

In one non-limiting example, the binder comprises two coupling agents. A non-exclusive example of a binder comprising two coupling agents may comprise between zero (0) and two (2) weight percent of A-187 organo silane and between zero (0) and three (3) weight percent of A-1100 organo silane based on total solids.

A non-limiting embodiment of a binder useful in the present invention may also include a lubricant. The lubricant may be, for example, a cationic lubricant. Non-limiting examples of cationic lubricants suitable in the present invention include lubricants with amine groups, lubricants with ethoxylated amine oxides, and lubricants with ethoxylated fatty amides. A non-limiting example of a lubricant with an amine group is a modified polyethylene amine, e.g. EMERY 6717, which is a partially amidated polyethylene imine commercially available from Cognis Corporation of Cincinnati, Ohio.

In one non-limiting embodiment, the amount of lubricant can comprise zero (0) to five (5) weight percent of the binder based on total solids. In another non-limiting embodiment, the amount of lubricant can comprise between one (1) and two (2) weight percent of the binder based on total solids.

Although not required, minor amounts of various additives can also be present in the binder such as anti-static agents, fungicides, bactericides, and/or anti-foaming materials. In one non-limiting embodiment, the binder also comprises an anti-foaming material. A non-limiting example of an anti-foam material suitable for use in the present invention is “Drewplus L-140”, which is commercially available from the Drew Industrial Division of Ashland Specialty Chemical Company. In one non-limiting embodiment, the amount of anti-foaming material can comprise less than one tenth (0.1) weight percent of the binder based on total solids.

In further embodiments, organic and/or inorganic acids or bases in an amount sufficient to provide the binder with appropriate pH (typically 2 to 10) can be included in the binder. For example, in one-non-limiting embodiment, glacial acetic acid may be added to lower the pH. In some non-limiting embodiments, the pH of the binder is between about four and six.

The binder may further include a carrier, such as water, preferably deionized water. The carrier is present in an amount effective to give a total solids (non-volatile) content sufficient to provide a viscosity suitable for application to the fibers. Generally, the water is present in an amount sufficient to yield a total solids content in the range of from about 8 to about 20 weight percent and preferably from about 9 to about 12 weight percent. That is, water may be present in an amount ranging from about 88 to about 91 weight percent of the binder. The selection of the total solids content of the binder may be determined based on the desired loss on ignition.

A binder for use in one non-limiting embodiment of the present invention may be prepared in accordance with the following formulation:

TABLE 1

| | Amount | % of |
|---|---|---|
| Component | (parts by weight) | Solids |
| Water (Main Mix) | 34 | 0% |
| Acetic Acid¹ | 2.2 | 0% |
| First Silane² | 1.95 | 1.05% |
| Second Silane³ | 3.88 | 1.58% |
| Water/Anti-foam Material | 3 | 0% |
| Anti-foam Material⁴ | 0.077 | 0.005% |
| Hot Water/Lubricant | 3 | 0% |
| Acetic Acid | 0.76 | 0% |
| Lubricant⁵ | 1.95 | 1.27% |
| Minor Film-Former⁶ | 14.96 | 5.4% |
| Major Film-Former⁷ | 294.8 | 90.7% |

| | |
|---|---|
| Total Solids = | 100.0% |

¹Generic glacial acetic acid.
²A-187 gamma-glycidoxypropyltrimethoxysilane from OSi Specialties of Tarrytown, NY.
³A-1100 gamma-aminopropyltriethoxysilane from OSi Specialties of Tarrytown, NY.
⁴Drewplus L-140 from the Drew Industrial Division of Ashland Specialty Chemical Company. The amount of Drewplus L-140 shown in this row was mixed with water as shown in the prior row before being mixed with the other binder components.
⁵EMERY 6717 partially amidated polyethylene imine from Cognis Corporation of Cincinnati, Ohio. The amount of Emery 6717 shown in this row was mixed with the acetic acid prior to mixing with water to form the amount of mixture shown in the “Hot Water/Lubricant” row before being mixed with the other binder components.
⁶NEOXIL ® 8294 polyepoxide film-former from DSM Italia.
⁷NEOXIL ® 954/D aqueous emulsion of alkoxylated bisphenol A polyester resin from DSM Italia.

A binder comprising the ingredients in Table 1 may be prepared by first sequentially adding water, acetic acid, the first silane, and the second silane to a mix tank with agitation. The water/anti-foam material may be prepared as a premixture and then added to the mix tank. The hot water/acetic acid/lubricant mixture may next be prepared and added to the mix tank. The minor film-former and the major film-former may then be added directly to the mix tank. Finally, deionized water may be added to the mix tank until a final volume of one hundred gallons is attained.

In general, although not limiting, the loss on ignition (LOI) of the fiber glass may be less than one and one-half (1.5) weight percent. In other non-limiting embodiments, the LOI may be between eight tenths (0.8) and one and one-half (1.5) weight percent. In further non-limiting embodiments, the LOI may be between 0.85 and 1.15 weight percent.

As used herein, the term “loss on ignition” or “LOI” means the weight percent of dried binder present on the fiber glass as determined by Equation 1:

LOI=100×[(W_{dry}−W_{bare})/W_{dry}] (Eq. 1)

wherein W_{dry} is the weight of the fiber glass plus the weight of the binder after drying in an oven at 220° F. (about 104° C.) for 60 minutes, and W_{bare} is the weight of the bare fiber glass after heating the fiber glass in an oven at 1150° F. (about 621° C.) for 20 minutes and cooling to room temperature in a dessicator.

The binder can be applied to the filaments of the present invention by any of the various ways known in the art, for example, although not limiting herein, by contacting the filaments with a static or dynamic applicator, such as a roller or belt applicator, or by spraying or by other means. For a discussion of suitable applicators, see K. Loewenstein, The Manufacturing Technology of Continuous Glass Fibres, (3d Ed. 1993), at pages 165-72, which are hereby incorporated by reference.

After coating, the fiber glass filaments are gathered into at least one end, prior to being wound, using techniques known to those of ordinary skill in the art. The at least one end, is then wound on a high-speed, direct draw, multiple package winder 35 to form at least one direct draw package. In one non-limiting embodiment, each direct draw package contains only one end. The direct draw packages can then be at least partially dried in a dryer, for example, in an oven dryer 40, to reduce the water content and cure any curable components of the binder. For example, the direct draw packages may be dried in an oven dryer for 8 to 15 hours at temperatures between 240 and 300° F. In other non-limiting embodiments, the direct draw packages can be dried using dielectric drying techniques, such as microwave drying and radio frequency drying. The direct draw packages can then be assembled in packaging units 45 of the present invention for shipment to customers.

Bushings useful in forming fiber glass filaments and ends are typically characterized by number of splits/ends, throughput, number of tips, and tip size. Bushings generally known to those of ordinary skill in the art can be used. For example, bushings useful in a method of the present invention can be split four to twenty ways, can have a throughput of up to three hundred fifty pounds per hour, can have eight hundred to ten thousand tips, and can have tip diameters that produce filaments having diameters between six and twenty-three microns. In one non-limiting embodiment, the bushing may have a throughput between 150 and 300 pounds per hour and may be capable of forming between 1000 and 6000 filaments, each having a diameter between 9 and 16 microns. For additional information relating to bushings, see K. Loewenstein, The Manufacturing Technology of Continuous Glass Fibres, (3d Ed. 1993), at pages 119-165, which are specifically incorporated by reference herein.

A non-limiting embodiment of a direct draw winder useful in the present invention is a high-speed, multiple package direct draw winder. Direct draw winders useful in the present invention, in some embodiments, may advantageously allow larger fiber filaments and larger end sizes to be wound into packages for use in roving applications, reduce problems of catenary, and result in a flatter end for improved downstream processing. In one non-limiting embodiment, the direct draw winder can wind ends of fiber glass at speeds up to 4,500 meters per minute. Suitable winders are commercially available from Shimadzu Corporation of Japan and from Dietze and Schell of Germany. Such winders include, by way of non-limiting example, Model No. DRH-4T from Shimadzu Corporation and Model No. DS 360/2-6 from Dietze and Schell. As winder technology develops, direct draw winders may wind the ends at higher speeds. The winders are preferably capable of winding a plurality of direct draw packages at the same time. For example, depending on the winder used, two to twelve direct draw packages can be formed on a single winder. The above-referenced winders can wind six direct draw packages at the same time. In another non-limiting embodiment, winders useful in the present invention can have a collet diameter up to three hundred millimeters (typically, between two hundred and two hundred thirty millimeters). In other embodiments, larger diameter collets can be used.

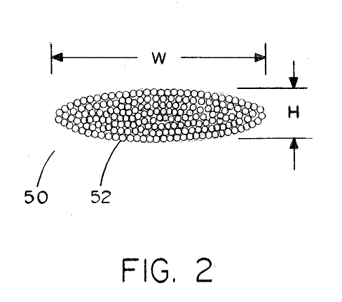

Each fiber glass end is wound on the direct draw winders to form a non-limiting embodiment of a direct draw package of the present invention. The number of filaments and the diameters of filaments used to form fiber glass ends can vary depending on the application. In one non-limiting embodiment, a fiber glass end on a direct draw package of the present invention can comprise between two hundred and eight hundred filaments per end. Non-limiting examples of filaments useful in forming ends can be “D”, “E”, “G”, “H”, “K”, “M”, or “T” fibers, having a diameter between six and sixteen microns. The filaments in each end can have the same diameter. The ends, in non-limiting examples, can be from fifty yards per pound to more than five thousand yards per pound. The fiber glass ends can have flatter, non-circular cross-sections when compared with ends formed using conventional processes. FIG. 2 illustrates a cross-section of a non-limiting embodiment of a fiber glass end of the present invention.

The dimensions of the cross-section of fiber glass ends of non-limiting embodiments of the present invention can be characterized in terms of the end's aspect ratio. As used herein, the term “aspect ratio” refers to the cross-sectional height (“H” in FIG. 2, the shorter dimension) divided by its cross-sectional width (“W” in FIG. 2, the longer dimension). The aspect ratios of fiber glass ends may be selected based on the application in which they will be used. Because of difficulties in measuring the actual cross-sectional height and cross-sectional width of an end (due to the size of the end and the number of filaments), the aspect ratio of an end may be determined and expressed as an “effective aspect ratio.” Example 2 describes how an effective aspect ratio of an end may be calculated. The effective aspect ratios of the fiber glass ends, in non-limiting embodiments of the present invention, may be greater than 5.9. In other non-limiting embodiments, the effective aspect ratios are between 5.9 and 10. The selection of an aspect ratio or effective aspect ratio for a particular fiber glass end may depend on a number of factors including, for example, the desired application for the fiber glass, the chop length, and the binder applied. The aspect ratio of an end may change as the end is wound due, for example, to winding tension and contact with other portions of the end.

Direct draw packages wound using direct draw winder may have a number of advantageous properties. The ends on direct draw packages may be of a generally uniform size. The fiber glass ends on the direct draw package, in other non-limiting embodiments, may or can also have desirable “wet out” properties when the end is mixed with a resin. The improved wet out properties may or can be characterized by improved diffusion of resin within the end (i.e., the resin penetrates the end more quickly).

Direct draw packages are cylindrically shaped and have a hollow center. The direct draw package can be wound such that the end can be paid out or unwound from the inside of the direct draw package. The dimensions of a direct draw package may vary, depending upon the particular product (e.g., the diameter and type of fiber being formed) and/or the winder, and are generally determined based on convenience in later handling and processing. In another non-limiting embodiment, the end can be withdrawn from the outside of the direct draw package.

Direct draw packages can be a number of sizes. Direct draw packages that may be used to form a single roving or roving product may be substantially the same size or may contain the same amount of glass. For example, direct draw packages may be about twenty centimeters to about thirty and one-half centimeters (about eight to about twelve inches) in diameter and may have a length of about five centimeters to about thirty and one-half centimeters (about two to about twelve inches). The size of the direct draw package is governed primarily by economics and not technical considerations. The sides of the direct draw package can be squared (e.g., not round or tapered).

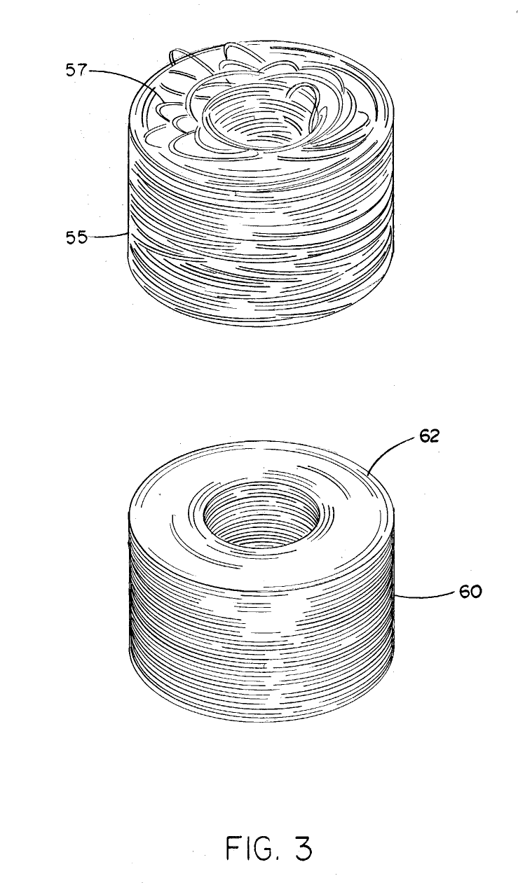

When direct draw products are used to form assembled rovings of the present invention (discussed in more detail below), the assembled rovings exhibit reduced catenaries or looping. Rovings, in non-limiting embodiments of the present invention, may or can have fewer loops and catenaries than conventional assembled rovings. FIG. 3 shows a conventional assembled roving 55 with loops and catenaries on one of its substantially flat surfaces 57 as well as an assembled roving 60 of the present invention that is substantially free of catenaries and loops on one of its substantially flat surfaces 62.

As used herein, “catenary” refers to the sag of multi-end material. Typical fiber glass rovings can sag fifteen to twenty-five centimeters (six to ten inches) over a fifteen meter (fifty foot) length. This sag can interfere with machinery and/or other nearby rovings and cause undesirable process interruptions. The catenaries can, for example, cause looping and snarling in the processing of the ends from the packages into manufactured products. Possible causes of catenaries may include, for example, tension variations and geometry effects during winding. As noted above, direct draw packages when combined into a roving, in non-limiting embodiments of the present invention, have fewer catenaries than rovings formed from conventional forming packages.

Assembled rovings of the present invention formed from direct draw packages avoid loops and catenaries because each direct draw package comprises a single end. Conventional forming packages used in roving packages involve winding multiple ends on a single forming package. Catenaries and looping problems result due to different tension variations and different lengths of ends being wound onto a single package.

As illustrated in FIG. 1 and discussed above, a direct draw package may be formed utilizing a source of batch materials (e.g., storage hoppers 5 for batch materials), a blender 10 or other mixing apparatus, a furnace 15, at least one bushing 20, at least one binder applicator 30, at least one direct draw winder 35, and a drier 40. As noted above, molten glass may also be supplied by indirect, or marble-melt, fiber forming operations.

The present invention relates to rovings and methods for forming rovings. A non-limiting embodiment of a roving of the present invention comprises a plurality of direct draw packages. Each direct draw package is formed using a direct draw winder.

In a non-limiting embodiment of the present invention, the ends or ends from a plurality of direct draw packages can be combined to form a roving package at the point of use. For example, in a spray forming application, the ends or ends from a plurality of direct draw packages are combined and fed directly to the roving gun. Each direct draw package, in one embodiment, comprises a single fiber glass end. By combining the ends from a plurality of direct draw packages to form a roving package at the point of use, non-limiting embodiments of the present invention provide users flexibility in the number of ends used in the roving product. For example, if a user wants a roving product with more ends for a particular application, then the user can include ends from additional direct draw packages to form the roving product. This feature can give a user greater control over throughput (e.g., pounds of glass per hour through a chopping gun). Thus, a user may increase throughput by increasing the number of ends or ends passed through the chopping gun.

In one non-limiting embodiment, a roving of the present invention can comprise between ten and two hundred fiber glass ends. In another non-limiting embodiment, the roving comprises up to fifty ends. In a further non-limiting embodiment, the roving comprises between twenty and fifty ends. Each end can be wound on its own direct draw package formed using a high-speed, direct draw, multiple package winder. Each end, in non-limiting embodiments, can comprise up to eight hundred filaments. The yields of the roving products can also vary depending on the application. In one non-limiting embodiment, the yields of the roving are between one hundred yards per pound and eighteen hundred yards per pound. In other embodiments, the yields are up to three hundred yards per pound. In further embodiments, the yields are between one hundred and three hundred yards per pound. in further embodiments, the yields are between one hundred fifty and two hundred fifty yards per pound.

In one non-limiting embodiment, each direct draw package is paid out from the interior, meaning that the end of the end is pulled from the inside of the package such that the package unwinds from the inside outward. In another non-limiting embodiment, the direct draw packages can be paid out from the exterior of the direct draw package. When direct draw packages are paid out from the interior, a plurality of packages can be aligned such that the plurality of packages are paid out through the centers of the packages. For example, the packages can be stacked and the ends from each package can be fed through the center of the packages. The ends from the stacked packages can be combined to form a roving of the present invention.

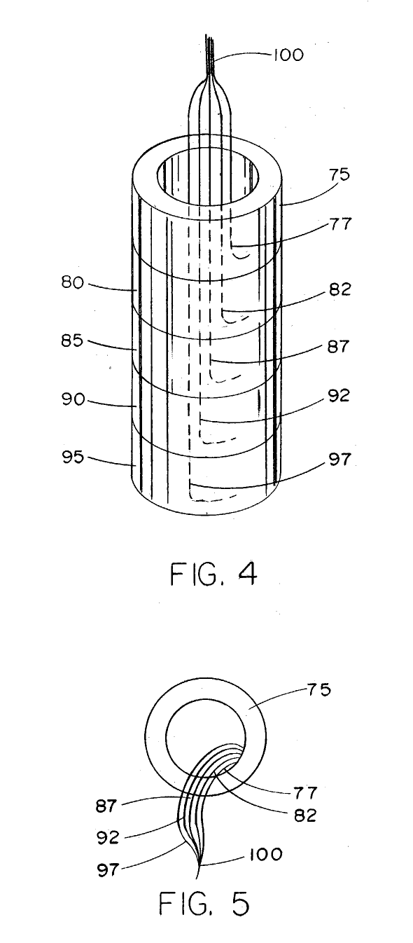

FIGS. 4 and 5 illustrate how direct draw packages can be stacked and paid out through the hollow centers of the packages in a non-limiting embodiment. As shown in FIGS. 4 and 5, five direct draw packages 75,80,85,90,95 are stacked. Each direct draw package includes an end 77,82,87,92,97 that is paid out through the center of the packages, and combined with the other ends to form a strand 100. Depending on the number of direct draw packages combined to form the roving, any number of direct draw packages can be stacked or any number of stacks of direct draw packages can be combined to form the roving. In other words, the combined ends 100 from the stack shown in FIG. 4 can be combined with combined ends from another stack to form a roving.

The number of ends used to form the roving product may depend on the application. As noted above, a roving in one non-limiting embodiment may comprise between ten and two hundred fiber glass ends, and, in further non-limiting embodiments, up to fifty ends. In other embodiments, the roving may comprise up to forty ends. In one embodiment, a roving may comprise between twenty and fifty ends. In other embodiments, the roving may comprise between twenty-four and forty ends.

The rovings of the present invention can provide improved splitting efficiencies as compared to conventional assembled rovings. Rovings of the present invention can advantageously have essentially complete splitting efficiency. In one non-limiting embodiment, rovings of the present invention can advantageously provide splitting efficiencies greater than 90%. In other non-limiting embodiments, the splitting efficiency can be between 95% and 100%. In further non-limiting embodiments, the splitting efficiency can be 100%.

For example, a customer may require a roving product with at least forty ends. In order to account for splitting efficiency issues, a manufacturer may produce a conventional assembled roving product with forty-eight ends. Roving products in a non-limiting embodiment of the present invention can be formed from less than forty-eight ends, while advantageously providing the required number of chopped ends for use in the application.

Rovings of the present invention can exhibit additional desirable characteristics. For example, roving products of the present invention can or may demonstrate improved end integrity. End integrity refers to the ability of the filaments in an end to remain in an end when chopped.

Non-limiting embodiments of rovings of the present invention can or may perform well when chopped, mixed with resin, sprayed, and rolled out to form a composite during gun roving operations. For example, when rolling out the fiber glass/resin mixture, using rovings of the present invention can or may reduce “springback” and “conformity.” As used herein, “springback” refers to a chopped fiber glass end's return to its original shape after it has been rolled. For example, after conventional assembled roving products are sprayed on a mold using a roving gun and are rolled by an operator, the ends may initially flatten, but subsequently return to their original shapes. As used herein, “conformity” refers to a chopped fiber glass end's ability to conform to the surface of the mold, especially the mold edges and corners, during the rolling process.

In one embodiment, a roving of the present invention, after being chopped and sprayed from a roving gun and mixed with a resin, has a conformity of less than 1.5. In another embodiment, a roving of the present invention, after being chopped and sprayed from a roving gun and mixed with a resin, has a conformity between 0.3 and 1.5.

A non-limiting embodiment of a method of the present invention for forming rovings comprises aligning a plurality of direct draw packages, each direct draw package having a hollow center and having a single fiber glass end, feeding the end from each package through the centers of the direct draw packages, and combining the ends to form a roving. The direct draw packages can be, for example, stacked vertically as shown in FIGS. 4-5, or aligned horizontally. A number of other alignments could be used.

The present invention also relates to assembled rovings or roving balls. An assembled roving of the present invention or “roving ball” comprises a single roving package formed from a plurality of direct draw packages of the present invention. The assembled roving is formed by winding the ends from a plurality of direct draw packages about a collet rotating about a horizontal, longitudinal axis. Rovings formed in this manner will be referred to herein as “assembled direct draw rovings” or “assembled rovings.” Assembled rovings of the present invention, in one non-limiting embodiment, may be formed using a roving winder, such as Model No. 868 or Model No. 858, both of which are commercially available from FTS/Leesona of Burlington, N.C. When a roving winder, such as the Leesona 868, is used, the direct draw packages may be wound into assembled direct draw roving products at speeds of between 950 and 1250 feet per minute. The selection of winding speeds is often a compromise of productivity and space limitations. Often, economic considerations govern the selection of winding conditions. Therefore, any specifications related to winding conditions of the roving winder, unless otherwise stated, should not be viewed as technically limiting on the present invention.

An anti-static agent, such as product number EM-6661-A from Cognis Corporation of Cincinnati, Ohio, may be applied to the ends from the direct draw packages prior to winding in order to reduce static charge, which can lead to chopped strands repelling each other and causing application problems for the user. In one non-limiting embodiment, the anti-static agent can be applied at a rate of 0.1 milliliters per minute.

In the present invention, the number of ends used to form an assembled direct draw rovings can vary depending on the application. In one non-limiting embodiment of the present invention, an assembled direct draw roving for use as gun roving (e.g., fed to a chopper gun, chopped, mixed with a resin, and sprayed) is assembled from between ten and two hundred direct draw packages of the present invention, and, in further non-limiting embodiments, between thirty and fifty direct draw packages or between twenty-four and forty packages. Each direct draw package, in one non-limiting embodiment, has a single end of fiber glass filaments and is formed using a high-speed, direct draw, multiple package winder. In one non-limiting embodiment, the direct draw packages are wound using winders such as Model No. DRH-4T from Shimadzu Corporation and Model No. DS 360/2-6 from Dietze and Schell, at winding speeds of between 500 and 6500 revolutions per minute. Each end, in non-limiting embodiments, can comprise between one hundred and one thousand filaments. The direct draw packages, in non-limiting embodiments, are coated with a binder during forming, such as the binders previously discussed. Assembled rovings of the present invention can or may exhibit lower payout tensions than conventional assembled rovings.

In one embodiment, an assembled roving of the present invention, after being chopped and sprayed from a roving gun and mixed with a resin, has a conformity of less than 1.5. In another embodiment, an assembled roving of the present invention, after being chopped and sprayed from a roving gun and mixed with a resin, has a conformity between 0.3 and 1.5.

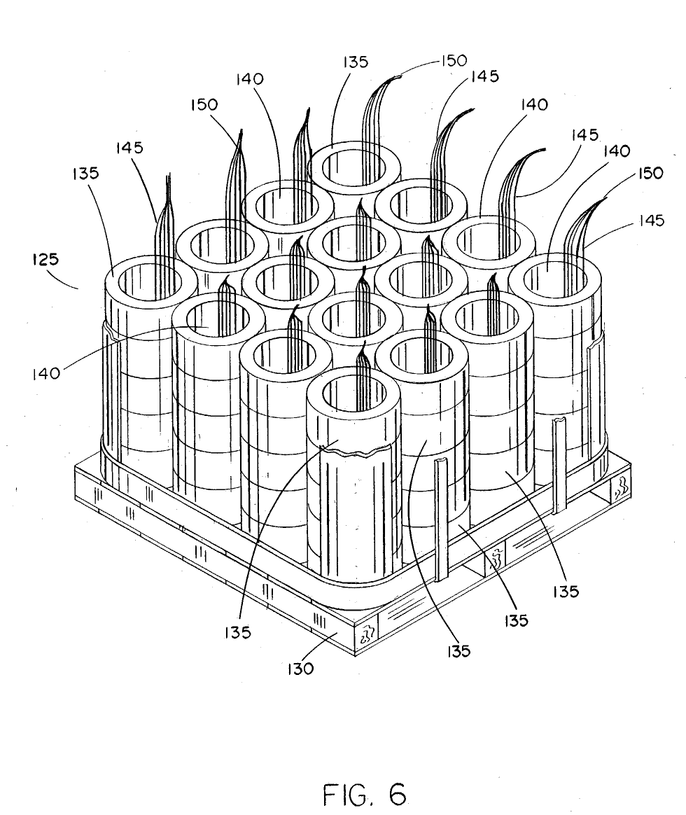

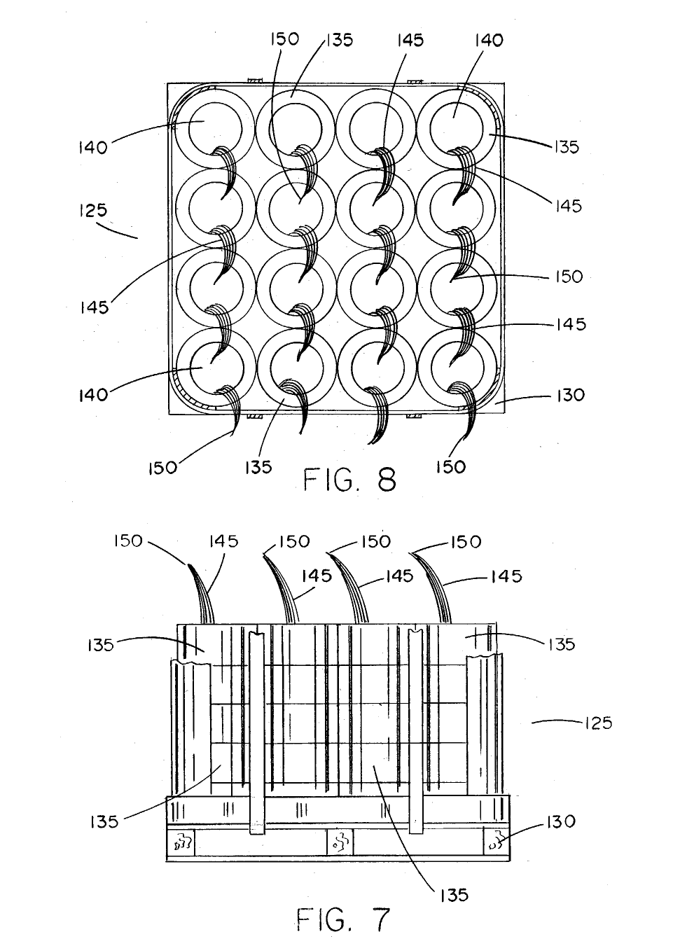

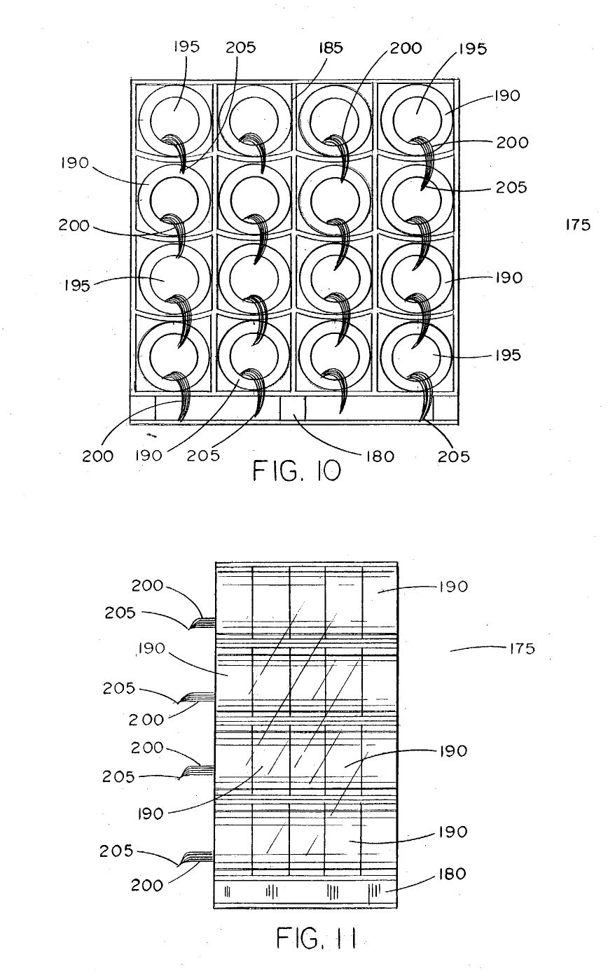

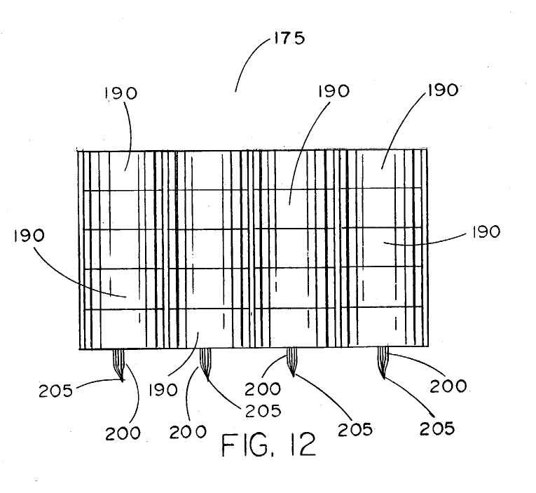

The present invention also relates to packaging units. A number of different packaging units in addition to the ones discussed and illustrated herein could be utilized. FIGS. 6-12 illustrate two non-limiting embodiments of packaging units of the present invention. Depending on the roving application and the number of direct draw packages used to form the roving, any number of arrangements of direct draw packages on the pallets can be used. The arrangement of direct draw packages can utilize the hollow centers of the direct draw packages to pay out a single stack of packages at the same time. When multiple stacks are used to form the roving, the combined ends from each stack of direct draw packages can be combined to form the roving.

Because of pallet size limitations, shelf-size limitations, and shipping concerns, it may be desirable to confine packaging units of the present invention to a certain maximum size. Thus, numerous stacks of direct draw packages can be required to form the roving. While the embodiments shown have five direct draw packages per stack, a stack can contain any number of packages.

FIGS. 6-8 provide perspective, side, and top views of a non-limiting embodiment of a packaging unit of the present invention. In the embodiment shown, the packaging unit 125 comprises a pallet 130 and a plurality of direct draw packages 135 arranged on the pallet 130, each direct draw package 135 having a hollow center 140 and having a single end 145, wherein the plurality of direct draw packages are arranged such that the ends from each of the plurality of direct draw packages can be paid out from the center of the packages and combined to form a roving. The packaging unit 125 in the embodiment shown comprises eighty direct draw packages 135. The eighty direct draw packages are arranged in sixteen stacks of five packages each. The five ends from each stack are combined to form a stack end 150 for each stack. Although not shown in FIGS. 6-8, the stack ends 150 can be combined to form a roving for use in the desired application. In another non-limiting embodiment, eighty direct draw packages can be arranged in ten stacks of eight packages.

The number of direct draw packages paid out to form a roving may be determined based on the amount of fiber glass (e.g., the yardage) that the gun roving operator wants to feed to the gun. The number of direct draw packages paid out to form a roving may also depend on the size of the end in each direct draw package. For example, a fewer number of large end packages may provide the same yardage as a larger number of small end packages.

In one non-limiting embodiment, twenty-eight to seventy-five direct draw packages can be paid out to form a roving. Thus, in a packaging unit comprising eighty direct draw packages, a set of forty direct draw packages (e.g., eight stacks of five direct draw packages, five stacks of eight packages, etc.) can be paid out first. The first forty direct draw packages can be connected to the second forty direct draw packages in order to provide a continuous supply of roving. In other words, when the first forty packages are completely fed, the next forty packages immediately, and without interruption, can begin dispensing to form the roving. Likewise, a plurality of packaging units can be connected to provide a longer supply of roving, such that the supply of roving is not interrupted.

The direct draw packages can be arranged on the pallet in a number of ways. In selecting a configuration for arranging the direct draw packages, important considerations include being able to combine ends from multiple packages at the same time, being able to tie subsequent packages together for a continuous or somewhat continuous feed to a roving gun, being able to ship the packages to the customer in an efficient manner, and others. The embodiments discussed below are examples of ways in which the direct draw packages may be assembled and shipped and are due, in part, to the ability to pay out the direct draw packages from the inside.

In one embodiment, the direct draw packages can be stacked vertically as shown in FIGS. 6-8. In this embodiment, the packages are shown to be arranged in sixteen stacks of five packages. The arrangement (number of stacks; number of packages per stack) can vary depending on the number of direct draw packages needed to form the roving, the size of the pallet, how the packaging units are to be connected, etc.

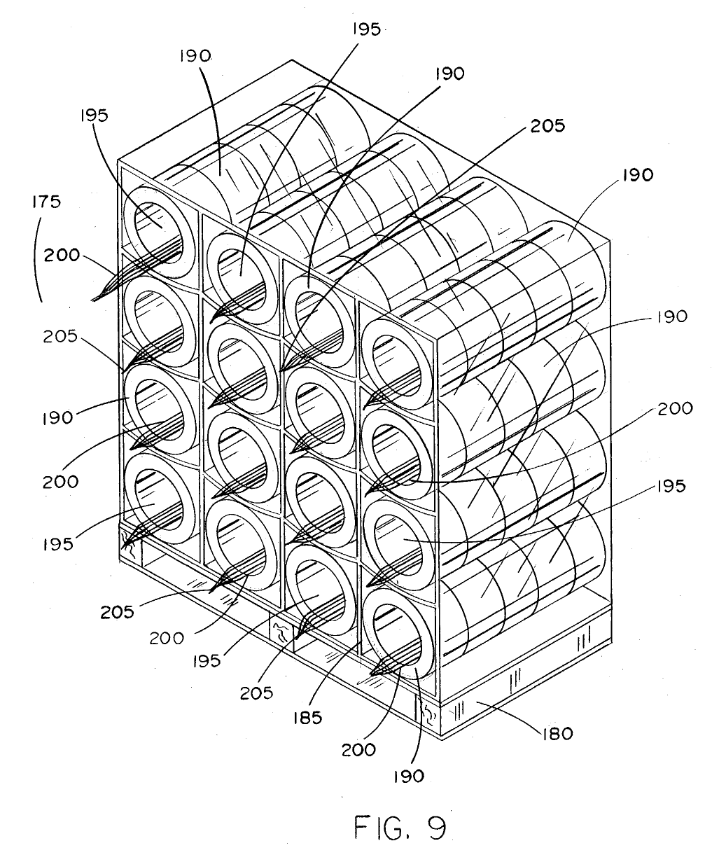

In other embodiments, the direct draw packages can be arranged in horizontal rows. In these non-limiting embodiments, a package rack may be utilized to prevent the packages in adjacent rows from contacting each other. FIGS. 9-12 illustrate a non-limiting embodiment of the present invention in which the direct draw packages are arranged in horizontal rows.

In the embodiment shown in FIGS. 9-1, the packaging unit 175 comprises a pallet 180, a rack 185 resting on the pallet 180, and a plurality of direct draw packages 190 arranged on the rack 185, each direct draw package 190 having a hollow center 195 and having a single end 200, wherein the plurality of direct draw packages are arranged such that the ends from each of the plurality of direct draw packages may be paid out from the center of the packages and combined to form a roving. The packaging unit 175 in the embodiment shown comprises eighty direct draw packages 190. The eighty direct draw packages are arranged in sixteen rows of five packages each. The five ends 200 from each row are combined to form a row end 205 for each stack. Although not shown in FIGS. 9-12, the row ends 205 can be combined to form a roving for use in the desired application.

In one non-limiting embodiment, forty direct draw packages can be paid out to form a roving. Thus, in a packaging unit comprising eighty direct draw packages, a set of forty direct draw packages (e.g., eight rows of five direct draw packages, five rows of eight packages, etc.) can be paid out first. The first forty direct draw packages can be connected to the second forty direct draw packages in order to provide a continuous supply of roving. In other words, when the first forty packages are completely fed, the next forty packages immediately, and without interruption, can begin dispensing to form the roving. Likewise, a plurality of packaging units can be connected to provide a longer supply of roving, such that the supply of roving is not interrupted.

In a further non-limiting embodiment of the present invention, the packaging units of the present invention can be re-used. In other words, after the direct draw packages in a packaging unit are used, the packaging units can be returned to the roving manufacturer to be re-filled. This feature can be particularly advantageous when a rack is used to control the alignment of the direct draw packages.

The present invention also relates to composite products, methods for forming composite products, and apparatuses for forming composite products. A non-limiting embodiment of a composite product of the present invention comprises a mixture of chopped fiber glass ends from direct draw packages and a resin. The chopped fiber glass ends can be from a roving product of the present invention. In other words, the chopped fiber glass ends can be from a plurality of direct draw packages that provides ends to form a roving to be chopped and used. Resins useful in composite products of the present invention can include, by way of non-limiting examples, polyesters, thermosetting polyesters, epoxy vinyl esters, urethanes, dicyclopentadiene, and other thermosetting materials. The fiber glass/resin mixture rolls out easily with less spring back and conformity issues around the edges and corners of the mold.

A non-limiting embodiment of a method of the present invention for forming composite products comprises obtaining a roving, supplying the roving to a roving gun, chopping the roving, mixing the chopped roving with a resin, spraying the mixed roving and resin on a mold, and rolling the mixed roving and resin on the mold. In one non-limiting embodiment, obtaining a roving comprises combining a plurality of fiber glass ends from direct draw packages to form a roving.

In some non-limiting embodiments, methods for forming composite products may further comprise controlling static in the roving. The potential for static in the roving product can be controlled, in a number of non-limiting ways, such as by adding anti-static agents to the binder, modifying the composition of the roller (or cot) in the chopper, dispersing an anti-static agent in the air feed to the gun, utilizing an ionization chamber, and applying a voltage to the roving product prior to chopping.

Composite products of the present invention can include, for example, boats, boat hulls, vehicle parts, bathtubs, showers, camper tops, and others.

An embodiment of a system of the present invention for forming composite products may comprise a plurality of direct draw packages, each having a fiber glass end, a source of resin, a roving gun, and a mold, wherein a roving is obtained from the plurality of direct draw packages, the roving is chopped and mixed with a resin, the mixed roving and resin are sprayed on a mold, and the mixed roving and resin are rolled on the mold. The direct draw packages can be arranged on a packaging unit of the present invention.

In addition to gun roving operations, the rovings of the present invention can be used in a number of other operations, including mats, panels, and other applications where a roving product comprising a plurality of ends is used and similar issues (e.g., split efficiency, springback, conformity, etc.) are of concern.

An embodiment of the present invention will now be illustrated in the following specific, non-limiting examples.

### EXAMPLE 1

Molten glass was formed in a furnace and supplied to a bushing using techniques known to those of ordinary skill in the art. The molten glass passed through a bushing to form fiber glass filaments. The bushing had a throughput of 200 pounds per hour, had 2400 tips, each tip having a diameter between 9 and 13 microns, and was split 6 ways. This bushing produces 2,400 fiber glass filaments having diameters between 9 and 13 microns each. The nominal filament diameter was 10.8 microns (“H” filament).

binder applicator. The binder used to coat the fiber glass filaments was prepared in accordance with the formulation set forth in Table 1. The nominal loss on ignition of the fiber glass was one (1.0) weight percent.

After coating, the fiber glass filaments were gathered into six (6) ends, prior to being wound, using techniques known to those of ordinary skill in the art. The six (6) ends were then wound on a Model No. DRH-4T winder, commercially available from Shimadzu Corporation. Each end was wound into a direct draw package. The winder was operating at a winding speed of 4,000 meters per minute.

The direct draw packages were then dried in an oven dryer for 10 hours at a temperature between 240 and 300° F.

The direct draw packages were then used to make an assembled direct draw roving. Twenty-eight direct draw packages were loaded onto a creel to be feed to the roving winder. The direct draw packages were fed to a Model 868 roving winder, commercially available from FTS/Leesona of Burlington, N.C. The roving winder wound the direct draw packages to form an assembled direct draw roving at a speed of 1100 feet per minute. EM-6661-A anti-static agent, commercially available from Cognis, was applied to the ends from the direct draw forming packages prior to winding the assembled direct draw roving package at a rate of two milliliters per minute.

The conformity of the assembled direct draw roving was then compared to the conformity of a conventional assembled roving. The packages used to form the conventional assembled roving used in this comparison were not wound using a direct draw winder. Rather, the forming packages were wound using a conventional forming winders at a winding speed of 4230 meters per minute. Each forming package was split two ways (i.e., two ends wound on each forming package), with each end having two hundred filaments having a nominal diameter of 10.8 microns (“H” filament). Prior to winding, the fiber glass filaments were at least partially coated with a binder using a binder applicator. The binder used to coat the fiber glass filaments was prepared in accordance with the formulation set forth in Table 1. The nominal loss on ignition of the fiber glass was one (1.0) weight percent. Twenty-eight forming packages were fed to a Leesona Model 868 roving winder. The roving winder wound the forming packages to form a conventional assembled roving at a speed of 1100 feet per minute. EM-6661-A anti-static agent, commercially available from Cognis, was applied to the ends from the direct draw forming packages prior to winding the assembled direct draw roving package at a rate of two milliliters per minute.

The conformity was measured as follows. First, the assembled direct draw roving was chopped, mixed with a resin, and sprayed onto a “step mold.” The “step mold” is a mold with the appearance of a staircase having four stairs, each stair being ten inches wide and ten inches tall. The assembled direct draw roving and resin were fed to a Magnum atomizing spray gun. The resins used in this Example was Polylite 33087-00 polyester resin, which is commercially available from Reichhold, Inc. The glass-to-resin ratio was 30% by weight. After spraying the chopped roving/resin mixture onto the step mold, an operator used a steel roller, similar to the rollers used in the shower/bath tub and boat industries, to roll over the sprayed roving/resin mixture. Because excessive rolling can effect conformity and spring back, the amount of rolling was limited in the test procedure. The rolling was limited to three passes parallel to the step and three passes perpendicular to the step. After the roving/resin mixture was rolled, a twelve inch length was marked along the length of one step. The number of chopped ends that did not conform to the outside corner of that step were counted. The total number of chopped ends that did not conform was divided by the linear distance (twelve inches) to obtain the conformity, which is measured as number of occurrences per inch. Adding the number of the bundles in violation in the marked distance, 12″, we obtain (occurrence/in) which is calculated by (sum of the bundles in violation/distance (in our case 12″).

The conformity of the conventional roving product was measured the same way by feeding the conventional roving product to a roving gun.

The conformity results were as follows:

| | Conformity |
|---|---|
| Product | (Occurrences/inch) |
| Assembled Direct Draw Roving Sample #1 | 1.5 |
| Assembled Direct Draw Roving Sample #2 | 1.0 |
| Conventional Assembled Roving - | 2.1 |
| Package 1, Sample #1 | |
| Conventional Assembled Roving - | 3.4 |
| Package 1, Sample #2 | |
| Conventional Assembled Roving - | 2.1 |
| Package 2, Sample #1 | |
| Conventional Assembled Roving - | 1.7 |
| Package 2, Sample #2 | |

As set forth in the above table, the assembled direct draw rovings of the present invention demonstrated improved conformity over conventional assembled rovings. The conformity of the direct draw assembled rovings was 1.5 occurrences or less per inch for each sample.

### EXAMPLE 2

In Example 2, a direct draw package having a single end was wound on a direct draw winder as describe above in Example 1. Likewise, a forming package was wound on a conventional forming winder as also described in Example 1. As noted above, the forming packages each contain two ends. For this Example, only one end from the forming package was measured. The aspect ratio of the end from the direct draw package was then compared to the aspect ratio of one of the two ends in the forming package.

The aspect ratio of the two products was measured as follows. Each end was fed through two perpendicular sensors. The sensors used were Model No. LS-7030M, commercially available from Keyence Corporation of Woodcliff Lake, N.J. The sensors were arranged perpendicularly so that they measured perpendicular dimensions of the end's cross-section as it passed between the sensors.

Two cross-sectional dimensions (referred to as X and Y) were measured. These perpendicular dimensions were measured by the sensors as the end was fed between the sensors. Due to technical limitations, it was not possible to control the orientation of the ends as they passed between the sensors, such that the sensors were not able to always measure the widest or most narrow dimensions of the cross-section. Thus, a formula was developed to calculate the apparent strand width based on each data pair. The apparent strand width, Z, is calculated by the following formula:

Z=\sqrt{X²+Y²}

The test conditions were the same for both the end from the direct draw package and the end from the conventional forming package, so the test described below was performed separately on both ends. An end was passed between the sensors at a rate of 8 feet per minute. The end was fed for 300 seconds, during which time 1000 pairs of data (X,Y) were recorded. An apparent strand width, Z, was calculated for each data pair using the above formula. The smaller of the two data points (min(X,Y)) was used as the cross-sectional height, such that a sample aspect ratio was calculated for each data pair (X,Y) using following formula:

$$AspectRatio = \frac{Z}{Min ( X , Y )}$$

Thus, for this test, one thousand sample aspect ratios were measured for both the direct draw end and the end from the conventional forming package. The smallest of these one thousand sample aspect ratios was selected as the effective aspect ratio for the end since the smallest sample aspect ratio would correspond to the situation where the widest and most narrow dimension of the end are aligned with the sensors measuring the X and Y dimensions.

The effective aspect ratio of ends from a conventional forming package were measured 2 times, and the effective aspect ratio was found to be in the range of 5.0 to 5.9. The effective aspect ratio of ends from direct draw packages were measured 3 times, and the effective aspect ratio was found to be in the range of 5.9 to 7.1.

Example 2 demonstrates that the ends from direct draw packages are flatter than ends wound on a conventional forming winder, which as discussed above, can have desirable effects when used in rovings.

Desirable characteristics, which can be exhibited by rovings of the present invention that can be assembled at the point of use, include, but are not limited to, the elimination of the need for an assembled roving process to produce rovings for use in gun roving and other applications, a reduction in manufacturing costs for the production of roving products, less handling during production of roving products, the production of roving products with substantially complete splitting efficiency, the production of roving products with minimized catenaries or sloughs that can cause problems during subsequent processing, the potential to produce roving products with a lower loss on ignition, the production of roving products that allow for improved resin penetration, a reduction in the amount of time spent finding ends during the use of roving products, a reduction of the amount of thin tube waste in using the rovings, the production of a roving product that is more easily rolled out after being mixed with a resin and sprayed onto a mold, the production of roving product with less spring back after it is mixed with a resin and sprayed on a mold, and the production of roving product with improved conformity after it is mixed with a resin and sprayed on a mold.

Desirable characteristics, which can be exhibited by assembled roving products of the present invention include, but are not limited to, a reduction in manufacturing costs for the production of roving products, less handling during production of roving products, the production of roving products with substantially complete splitting efficiency, the production of roving products with minimized catenaries or sloughs that can cause problems during subsequent processing, the potential to produce roving products with a lower loss on ignition, the production of roving products that allow for improved resin penetration, a reduction in the amount of time spent finding ends during the assembly of packages into assembled roving products, a reduction of the amount of thin tube waste in using the rovings, the production of a roving product that is more easily rolled out after being mixed with a resin and sprayed onto a mold, the production of roving product with less spring back after it is mixed with a resin and sprayed on a mold, and the production of roving product with improved conformity after it is mixed with a resin and sprayed on a mold.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

What is claimed is:

1. A fiber glass gun roving, comprising:
ten to two hundred fiber glass ends from a plurality of direct draw packages, each direct draw package having a single fiber glass end,
wherein each end comprises up to 800 filaments and wherein the effective aspect ratio of each end is greater than 5.9.

2. The gun roving of claim 1, wherein each end comprises up to 600 filaments.

3. The gun roving of claim 2, wherein the diameter of each filament is up to sixteen microns.

4. The gun roving of claim 1, wherein each end comprises up to 500 filaments.

5. The gun roving of claim 4, wherein the diameter of each filament is up to thirteen microns.

6. The gun roving of claim 1, wherein the gun roving comprises up to fifty fiber glass ends and wherein the yield of the gun roving is up to three hundred yards per pound.

7. The gun roving of claim 1, wherein the gun roving comprises up to forty fiber glass ends and wherein the yield of the gun roving is up to two hundred fifty yards per pound.

8. The gun roving of claim 1, wherein the diameter of each filament is between nine and thirteen microns, wherein each end comprises between 300 and 500 filaments, wherein the gun roving comprises between twenty and fifty fiber glass ends, and wherein the yield of the gun roving is between one hundred and three hundred yards per pound.

9. The gun roving of claim 1, wherein the roving exhibits a splitting efficiency greater than 90% after being chopped and sprayed from a roving gun.

10. The gun roving of claim 1, wherein the roving exhibits a splitting efficiency greater than 95% after being chopped and sprayed from a roving gun.

11. The gun roving of claim 1, wherein each end has an effective aspect ratio between 5.9 and 10.

12. The gun roving of claim 1, wherein each end has a non-circular cross-section.

13. The gun roving of claim 1, wherein the gun roving, after being chopped and sprayed from a roving gun and mixed with a resin, has a conformity of less than 1.5.

14. The gun roving of claim 13, wherein the gun roving, after being chopped and sprayed from a roving gun and mixed with a resin, has a conformity between 0.3 and 1.5.

15. The gun roving of claim 1, wherein a plurality of direct draw packages were wound on a direct draw winder.

16. The gun roving of claim 1, wherein each direct draw package comprises a cylindrical package with two substantially flat surfaces.

17. The gun roving of claim 1, wherein the ends are loosely grouped.

18. The gun roving of claim 1, wherein the gun roving is an assembled roving.

19. An assembled fiber glass roving, comprising:
a wound package comprising between ten and two hundred fiber glass ends from a plurality of direct draw packages, each direct draw package having a single fiber glass end,
wherein each end comprises up to 800 filaments and wherein the effective aspect ratio of each end is greater than 5.9.

20. The assembled fiber glass roving of claim 19, wherein each end comprises up to 600 filaments.

21. The assembled fiber glass roving of claim 20, wherein the diameter of each filament is up to sixteen microns.

22. The assembled fiber glass roving of claim 19, wherein each end comprises up to 500 filaments.

23. The assembled fiber glass roving of claim 22, wherein the diameter of each filament is up to thirteen microns.

24. The assembled fiber glass roving of claim 19, wherein the assembled fiber glass roving comprises up to fifty fiber glass ends and wherein the yield of the gun roving is up to three hundred yards per pound.

25. The assembled fiber glass roving of claim 19, wherein the assembled fiber glass roving comprises between up to forty fiber glass ends and wherein the yield of the gun roving is up to two hundred fifty yards per pound.

26. The assembled fiber glass roving of claim 19, wherein the diameter of each filament is between nine and thirteen microns, wherein each end comprises between 300 and 500 filaments, wherein the assembled fiber glass roving comprises between twenty and fifty fiber glass ends, and wherein the yield of the gun roving is between one hundred and three hundred yards per pound.

27. The assembled fiber glass roving of claim 19, wherein the assembled fiber glass roving exhibits a splitting efficiency greater than 90% after being chopped and sprayed from a roving gun.

28. The assembled fiber glass roving of claim 19, wherein the assembled fiber glass roving exhibits a splitting efficiency greater than 95% after being chopped and sprayed from a roving gun.

29. The assembled fiber glass roving of claim 19, wherein each end has an effective aspect ratio between 5.9 and 10.

30. The assembled fiber glass roving of claim 19, wherein each end has a non-circular cross-section.

31. The assembled fiber glass roving of claim 19, wherein the assembled fiber glass roving, after being chopped and sprayed from a roving gun and mixed with a resin, has a conformity of less than 1.5.

32. The assembled fiber glass roving of claim 31, wherein the assembled fiber glass roving, after being chopped and sprayed from a roving gun and mixed with a resin, has a conformity between 0.3 and 1.5.

33. The assembled fiber glass roving of claim 19, wherein a plurality of direct draw packages were wound on a direct draw winder.

34. The assembled fiber glass roving of claim 19, wherein each direct draw package comprises a cylindrical package with two substantially flat surfaces.

35. The assembled fiber glass roving of claim 19, wherein the assembled fiber glass roving is a gun roving.

36. A method for forming a fiber glass gun roving, comprising:
providing a plurality of direct draw packages, each direct draw package having a hollow center and a single fiber glass end, wherein each end was wound into a direct draw package using at least one direct draw winder, wherein at least four direct draw packages are capable of being wound on each direct draw winder, and wherein the effective aspect ratio of each end is greater than 5.9;
feeding the end from each direct draw package through the center of the direct draw package; and
combining the ends to form a gun roving.

37. The method of claim 36, wherein providing a plurality of direct draw packages comprises providing between up to fifty direct draw packages and wherein the yield of the gun roving is up to three hundred yards per pound.

38. The method of claim 36, wherein providing a plurality of direct draw packages comprises providing up to forty direct draw packages and wherein the yield of the gun roving is up to two hundred fifty yards per pound.

39. The method of claim 36, wherein the gun roving exhibits a splitting efficiency greater than 90% after being chopped and sprayed from a roving gun.

40. The method of claim 36, wherein the gun roving exhibits a splitting efficiency greater than 95% after being chopped and sprayed from a roving gun.

41. The method of claim 36, wherein each end has an effective aspect ratio between 5.9 and 10.

42. A method for forming an assembled fiber glass roving, comprising:
providing a plurality of direct draw packages, each direct draw package having a hollow center and a single fiber glass end, wherein each end was wound into a direct draw package using at least one direct draw winder, wherein at least four direct draw packages are capable of being wound on each direct draw winder, and wherein the effective aspect ratio of each end is greater than 5.9; and
winding the ends from the plurality of direct draw packages to form an assembled fiber glass roving.

43. The method of claim 42, wherein providing a plurality of direct draw packages comprises providing up to fifty direct draw packages and wherein the yield of the assembled roving is up to three hundred yards per pound.

44. The method of claim 42, wherein providing a plurality of direct draw packages comprises providing up to forty direct draw packages and wherein the yield of the assembled roving is up to two hundred fifty yards per pound.

45. The method of claim 42, wherein the assembled roving is cylindrical with two substantially flat surfaces and wherein each of the substantially flat surfaces are substantially free of catenaries.

46. The method of claim 42, wherein the assembled roving exhibits a splitting efficiency greater than 90% after being chopped and sprayed from a roving gun.

47. The method of claim 46, wherein the assembled roving exhibits a splitting efficiency greater than 95% after being chopped and sprayed from a roving gun.

48. A system for forming assembled fiber glass rovings, comprising:
a supply of molten glass;
at least one bushing;
at least one binder applicator;
at least one direct draw winder capable of simultaneously winding four or more direct draw packages; and
a roving winder;
wherein molten glass is supplied to the at least one bushing, wherein the at least one bushing forms fiber glass filaments, wherein the fiber glass filaments are at least partially coated with a binder, wherein the fiber glass filaments are gathered into at least four ends, wherein the at least four ends are wound into at least four direct draw packages on the at least one direct draw winder, each direct draw package having a single end, and wherein the at least four packages are assembled at the roving winder to form an assembled roving.

49. The system of claim 48, wherein the at least one bushing is able to produce at least four ends, each end having up to 600 filaments.

50. The system of claim 49, wherein the diameter of each filament is up to sixteen microns.

51. The system of claim 48, wherein the at least one bushing is able to produce at least six ends, each end having up to 500 filaments.

52. The system of claim 51, wherein the diameter of each filament is up to thirteen microns.

53. A method for forming composite products, comprising:
combining a plurality of fiber glass ends from a plurality of direct draw packages, each direct draw package having a single end, to form a roving;
supplying the roving to a roving gun;
chopping the roving;
at least partially mixing the chopped roving with a resin;
spraying the mixed roving and resin on a mold; and
rolling the mixed roving and resin on the mold;
wherein the direct draw packages are wound using a direct draw winder, wherein the direct draw winder is capable of simultaneously winding four or more direct draw packages, and wherein the ends from each direct draw package are combined to form the roving just prior to supplying the roving to the chopping gun.

54. The method of claim 53, wherein the roving exhibits a splitting efficiency greater than 90% after being chopped and sprayed from the roving gun.

55. The method of claim 54, wherein the roving exhibits a splitting efficiency greater than 95% after being chopped and sprayed from the roving gun.

56. The method of claim 53, wherein the roving exhibits a conformity of less than 1.5 after the mixed roving and resin are rolled on the mold.

57. The method of claim 56, wherein the roving exhibits a conformity between 0.3 and 1.5 after the mixed roving and resin are rolled on the mold.

58. A method for forming composite products, comprising:
winding a plurality of fiber glass ends from a plurality of direct draw packages, each direct draw package having a single end, to form an assembled roving;
supplying the assembled roving to a roving gun;
chopping the assembled roving;
at least partially mixing the chopped roving with a resin;
spraying the mixed roving and resin on a mold; and
rolling the mixed roving and resin on the mold;
wherein the direct draw packages are wound using a direct draw winder and wherein the direct draw winder is capable of simultaneously winding four or more direct draw packages.

59. The method of claim 58, wherein the assembled roving exhibits a splitting efficiency greater than 90% after being chopped and sprayed from the roving gun.

60. The method of claim 59, wherein the assembled roving exhibits a splitting efficiency greater than 95% after being chopped and sprayed from the roving gun.

61. The method of claim 58, wherein the assembled roving exhibits a conformity of less than 1.5 after the mixed roving and resin are rolled on the mold.

62. The method of claim 61, wherein the assembled roving exhibits a conformity between 0.3 and 1.5 after the mixed roving and resin are rolled on the mold.

63. The method of claim 58, wherein the assembled roving is cylindrical with two substantially flat surfaces and wherein each of the substantially flat surfaces are substantially free of catenaries.

64. A system for forming composite products, comprising:
a plurality of direct draw packages, each direct draw package having a single fiber glass end;
a source of resin;
a roving gun; and
a mold;
wherein the ends from the direct draw packages are supplied to the roving gun, wherein the ends are combined to form a roving just prior to supplying the ends to the roving gun, the roving is chopped and at least partially mixed with the resin, the mixed roving and resin are sprayed on the mold, and the mixed roving and resin are rolled on the mold.
